(19) United States
(12) Patent Application Publication
(10) Pub. No.: US 2003/0133864 A1
(43) Pub. Date: Jul. 17, 2003

(54) Central carbon dioxide purifier

(75) Inventors: John Fredric Billingham, Getzville, NY (US); Henry Edward Howard, Grand Island, NY (US); Kimberly Hershey, Grand Island, NY (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Praxair Technology, Inc., Danbury, CT

(21) Appl. No.: 10/274,303

(22) Filed: Oct. 17, 2002

Related U.S. Application Data
(60) Provisional application No. 60/330,203, filed on Oct. 17, 2001.
(60) Provisional application No. 60/330,150, filed on Oct. 17, 2001.
(60) Provisional application No. 60/350,688, filed on Jan. 22, 2002.
(60) Provisional application No. 60/358,065, filed on Feb. 19, 2002.

(51) Int. Cl. B01D 3/42

(52) U.S. Cl. 423/437.1; 203/73; 202/172; 203/80; 203/2; 202/160

(57) ABSTRACT

The invention disclosed herein generally relates to a system and a method for supplying a carbon dioxide fluid feed to a plurality of applications. The method of the invention comprises the steps of directing a fluid feed, that includes a carbon dioxide component, from a carbon dioxide purifying means to a plurality of applications including at least two distinct applications, whereby contaminants are combined with the fluid at said applications, thereby forming an effluent that includes at least a portion of the carbon dioxide component and at least a portion of said contaminants; directing said effluent from at least one of the applications to said carbon dioxide purifying means; and purifying the carbon dioxide of the effluent at the carbon dioxide purifying means, thereby producing the carbon dioxide component of the fluid feed. The system of the invention is an apparatus for conducting the method of the invention.

### RELATED APPLICATIONS

This application claims the benefit of U.S. Provisional Application No. 60/330,203, filed on Oct. 17, 2001, the entire teachings of which are incorporated herein by reference. This application also claims the benefit of U.S. Provisional Application No. 60/330,150, filed Oct. 17, 2001, No. 60/350,688, filed Jan. 22, 2002 and No. 60/358,065, filed Feb. 19, 2002, the entire teachings of all these applications are incorporated herein by reference.

### BACKGROUND OF THE INVENTION

The manufacture of integrated circuits generally involves a number of discrete steps that are performed on a wafer. Typical steps include depositing or growing a film, patterning the wafer using photolithography, and etching. These steps are performed multiple times to build the desired circuit. Additional process steps may include ion implantation, chemical or mechanical planarization, and diffusion. A wide variety of organic and inorganic chemicals are used to conduct or to remove waste from these applications. Aqueous-based cleaning systems have been devised to eliminate some of the organic solvent requirements, but they generate large quantities of waste streams that must be treated prior to discharge or reclamation. The need for large quantities of water is often a major factor in choosing a location for a semiconductor fabrication facility. In addition, the high surface tension of water reduces its effectiveness in applications requiring the cleaning of fine structures, and drying steps must be included in the process to remove all traces of moisture.

In recent years, supercritical carbon dioxide has been investigated as a potential replacement for some of the organic solvents and aqueous-based chemistries currently in use. Supercritical carbon dioxide systems have been used for decades in simple extraction applications, such as the decaffeination of coffee. The term supercritical fluid refers to a fluid that is above a critical temperature and pressure (e.g., at or above 31° C. and 1070 pounds per square inch absolute (psia) respectively, for carbon dioxide). Supercritical fluids have both gas- and liquid-like properties. The density of supercritical fluids can be varied as a function of temperature and pressure. Because solvating ability is a strong function of density this also means that the solvating properties can be varied. Pure supercritical carbon dioxide has solvent capabilities similar to a non-polar organic solvent such as hexane. Modifying agents such as cosolvents, surfactants, and chelating agents can be added to the carbon dioxide to improve its cleaning ability.

Semiconductor-applications can generally produce a range of contaminants with vapor pressure either above or below that of carbon dioxide. The lighter, higher vapor pressure components may be some combination of fluorine, light fluorinated hydrocarbons and atmospheric gases such as nitrogen and oxygen. Carbon dioxide can also be contaminated with non-volatile resist residue compounds and co-solvents, which are difficult to transfer because they can exist as a solid/liquid mixture in combination with vapor phase carbon dioxide. Also, carbon dioxide purity requirements for many semiconductor manufacturing applications exceed those of currently available delivered bulk carbon dioxide. Furthermore, if supercritical carbon dioxide is to be widely used in the semiconductor industry, the quantities consumed will likely preclude the economic viability of total dependence on delivered carbon dioxide. Finally, a semiconductor manufacturing facility can have a number of different applications with distinct requirements.

The prior art, however, does not teach a system or method by which these problems may be overcome. There is therefore a need for a method and apparatus for using carbon dioxide in a semiconductor manufacturing process that minimizes or eliminates these problems.

### SUMMARY OF THE INVENTION

The invention generally relates to a method and a system for supplying carbon dioxide to a plurality of applications.

The method of the invention includes the steps of directing a fluid feed, that includes a carbon dioxide component, from a first carbon dioxide purifying means to a plurality of applications including at least two distinct applications. At the applications, one or more contaminants are combined with the fluid, thereby forming an effluent at each application, wherein each effluent includes at least a portion of the carbon dioxide component and at least a portion of the contaminants. At least a portion of at least one effluent is directed to the first purifying means, whereby the carbon dioxide component of the effluent is purified, thereby forming the fluid feed.

The system of the invention includes a first carbon dioxide purifying means, which purifies a carbon dioxide component of an effluent to form a fluid feed that includes the carbon dioxide as a component of the fluid feed. The first purifying means includes at least one member of the group consisting of a catalytic oxidizer, a distillation column, a phase separator, and an adsorption bed. A supply conduit is included for directing the fluid feed from the first purifying means to a plurality of applications comprising at least two distinct applications. At the applications, one or more contaminants are combined with the fluid, thereby forming an effluent at each application, wherein each effluent includes at least a portion of the carbon dioxide component and at least a portion of the contaminants. A return conduit directs the effluent from at least one application to the first purifying means.

The advantages of the invention disclosed herein are significant. Practicing the invention can significantly reduce the cost and complexity of supplying high-purity carbon dioxide to the multiple distinct applications in a semiconductor manufacturing facility. By recycling carbon dioxide, the amount, and therefore the cost of externally supplied carbon dioxide is reduced. By purifying bulk make-up carbon dioxide prior to the applications, the cost is reduced because the bulk carbon dioxide supplied to the manufacturing facility can be purchased at a lower purity level. By providing a central purifier, economies of scale are realized over individual purification and delivery units. The cost of serving multiple applications is reduced, and the cost of treating the effluent of multiple applications having different contaminant compositions is also reduced. Additionally, effluent stream combination, either from a time-staggered operation of multiple tools of the same type, or from different tools, provides a more uniform effluent stream, which is more readily purified in a central purifier. Another key advantage of a central purifier is consolidation of the analytical requirements. Yet another advantage of a central purifier is that by using a bypass circuit, the central purifier can be operated continuously, avoiding stagnant legs that can accumulate contaminants, and allowing the applications to be operated in a batch mode. A further advantage is that by combining a central purifier with distributed local purifiers, effluent streams that are chemically incompatible can be pre-purified so that they can be combined and sent to the central purifier.

The combination of these advantages is expected to make supercritical carbon dioxide a viable replacement for existing organic solvent and aqueous chemistry applications, resulting in lower production costs for semiconductors.

### BRIEF DESCRIPTION OF THE DRAWINGS

FIG. 1 depicts an apparatus that is an embodiment of the invention.

FIG. 2 depicts an apparatus that is an alternative embodiment of the invention with a carbon dioxide source and multiple semiconductor manufacturing applications with multiple tools.

FIG. 3 depicts an apparatus that is a portion of an alternative embodiment of the invention, detailing the components of the first purifying means.

### DETAILED DESCRIPTION OF THE INVENTION

The foregoing and other objects, features, and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

The invention generally is related to a method and system for supplying carbon dioxide to a plurality, i.e., two or more, applications. As used herein, an application employs a fluid feed that includes a carbon dioxide component.

In a semiconductor fabrication facility, for instance, carbon dioxide can be employed during wafer cleaning, photoresist deposition, chemical fluid deposition, photoresist developing, photoresist removal, photoresist developing, and other applications known to the art where solvents or aqueous solutions are used. Each application can require different operational conditions with respect to the carbon dioxide-containing fluid feed.

The equipment used to perform an application is generally is referred to as a tool. Often, the same application is conducted using multiple tools, each tool operated independently of the others. A tool can include one or more chambers and each chamber can independently process its own wafer, or other workpiece.

Applications that are distinct are applications that differ in at least one parameter of the fluid feed being delivered to the application, or the effluent leaving the application. Parameters can be chemical or physical conditions or can be related to volume and timing at which a fluid feed that includes a carbon dioxide component is employed at the application. Examples of parameters include flow rate, flow cycle (continuous or batch mode), cycle time, amount and kind of additives in the second component, temperature, pressure, contaminants, and other variables. As used herein, tools or chambers within the tool are distinct applications if they employ feed streams or produce effluents that differ in at least one parameter.

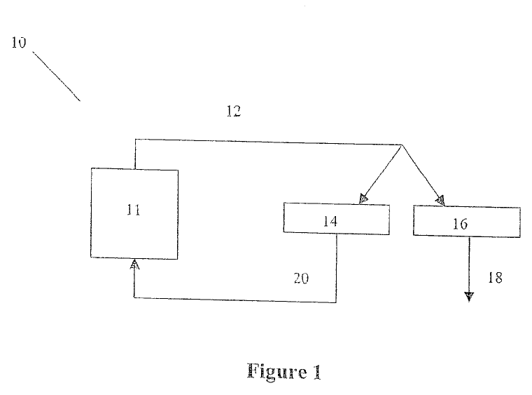

FIG. 1 shows apparatus 10 of the invention, which can also be used to conduct the method of the invention. The system includes a first carbon dioxide purifying means 11, which can purify a carbon dioxide component of an effluent, thereby forming a fluid feed containing a carbon dioxide component. The fluid feed can be directed from the first purifying means 11 via supply conduit 12 to a plurality of applications, including at least two distinct applications 14 and 16. Preferably, first purifying means 11 includes pressurization means such that the pressure in supply conduit 12 is greater than the pressure in return conduit 20. As discussed above, applications that are distinct employ fluid feeds that differ in at least one parameter, e.g. temperature, pressure, flow rate, timing of delivery of the fluid feed, amount or kind of additives present in the fluid feed, etc. At the applications, one or more contaminants, e.g. from a wafer being cleaned or processed, are combined with the fluid, thereby forming an effluent at each application. Return conduit 20 can direct at least a portion at least one effluent back to the purifying means to purify the carbon dioxide component of the effluent.

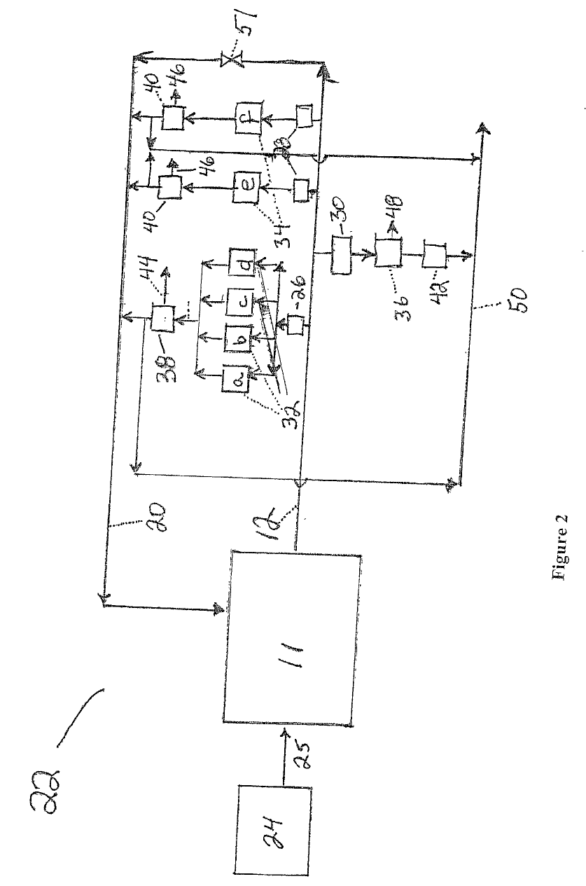

FIG. 2 shows apparatus 22 of the invention, which can also be used to conduct the method of the invention. Carbon dioxide from source 24 can be added to the system via conduit 25 to make up for losses in normal processing or to increase the amount of carbon dioxide in the system as additional applications are brought on line. Examples of carbon dioxide sources are a liquid carbon dioxide tank, a carbon dioxide generating plant, a railroad tank car, and a truck trailer. The carbon dioxide that is added can be purified by one of several means before it reaches the application. There can be a second carbon dioxide purifying means included in source 24, which contains at least a distillation column, a catalytic oxidizer, or an adsorption bed. When the carbon dioxide from the source is sufficiently pre-purified in this manner, it can be added to any point in the system. Preferably, however, carbon dioxide from the source is added to a point in the system, such as return conduit 20 or first purifying means 11, that allows the existing first purifying means 1 to be used, thus obviating the need for an additional, external purification unit.

As before, first purifying means 11 directs a fluid feed containing a carbon dioxide component to a plurality of applications. As used herein, a purifier can include one or more components such as phase separators, distillation columns, filters, adsorption beds, catalytic reactors, scrubbers, and other components known to the art. The resulting carbon dioxide fluid feed can contain less than 100 parts per million (ppm) of any impurity. Typically, the stream will contain less than 10 ppm of any impurity, and preferably, less than 1 ppm of any impurity. Another important element of means 11 is a purity analyzer. Analyzers for high purity gases include mass spectrometers of various kinds, and other detectors that are well-known to the art. Many such devices are commercially available and can be integrated into any of the systems or methods described herein.

Prior to the applications, customizing units 26, 28, and 30 modify the physical properties of the fluid feed of supply conduit 12. The customizing units can have a heat exchanger, a pressure controller, or both. As used herein, a heat exchanger is any device that can raise or lower the temperature of a feed, such as an electric heater, a refrigeration unit, a heat pump, a water bath, and other devices know to the art. As used herein, a pressure controller can be any device that changes the pressure of a feed, including a pump, a compressor, a pressure reducing valve, and other devices known to the art. The temperature and pressure can then be modified to values that are appropriate for each application. Preferably, the fluid feed will be a high pressure liquid or supercritical fluid, with pressure in the range of between about 650 to about 5000 pounds per square inch gauge (psig), more preferably in the range of between about 800 to about 3500 psig, and most preferably in the range of between about 950 to about 3000 psig. In a preferred embodiment, the customization unit forms the carbon dioxide component of the fluid feed into a supercritical fluid, i.e., temperature greater than about 31° C. and pressure greater than about 1070 psig.

The customization units can also incorporate a means to add a second component to the fluid feed for each application, where the second component is one or more co-solvents, surfactants, chelators, or other additives that enhance the performance of the fluid feed in each application. Alternatively, one or more of the heat exchanger, the pressure controller, or the means to add the second component may be incorporated directly into an application or tool.

Following the customization units, three distinct applications are shown, 32, 34, and 36. For example, application 36 could be a wafer cleaner that uses carbon dioxide snow to clean the wafer surface, application 32 could be a photoresist developer and application 34 could be a photoresist stripper. Applications 32 and 34 as shown have multiple tools, with four tools a, b, c, and d for application 32, and two tools e and f for application 34. Application 36 is shown with only one tool. As before, one or more contaminants are combined with the fluid feed at each application, forming an effluent for each tool that contains carbon dioxide, one or more contaminants, and any second component that was added. Effluent from applications with multiple tools can be combined, as shown for 32, or kept separate, as shown for 34.

In a preferred embodiment, each effluent can be sent to a third carbon dioxide purifying means 38, 40, or 42, which by reducing the pressure separates each effluent into a plurality of phases. Each third purification means 38, 40, or 42 can be a phase separator such as a simple disengagement drum, a multi-stage contactor, or other devices known in the art. Optionally 38, 40, or 42 can be combined with a heat exchanger to vaporize carbon dioxide in the effluent as a liquid and/or to heat the gas to counteract the cooling it experiences by being depressurized during phase separation. Alternatively, the third purifying means can include a distillation column, a catalytic oxidizer, or an adsorption bed.

Usually there will be a liquid phase enriched in, for, example, co-solvents and contaminants from the application, and depending on the contaminants and the composition of the second component, there may be more than one liquid phase. Also depending on the contaminants and second component composition, there can be a solid phase or a solid phase suspended in a liquid phase, which can be removed directly at each third purification means as waste streams 44, 46, and 48 by means such as a knockout pot, to allow droplets and particles to settle out by gravity. Optionally, further phase separation devices, such as coalescers and filters, can be used downstream of a gravity device to perform a more complete phase separation.

All phases can contain carbon dioxide, but generally the phase most enriched in carbon dioxide will be a gas stream, of which at least a portion is then directed to the first purifying means 11 via return conduit 20. The decision of whether, or how much of the effluent can be directed to first purifying means 11 or to waste stream 50 depends on several factors, the most important of which are pressure and composition. Effluent in return conduit 20 will typically operate at elevated pressure compared to first purifying means 11. If the effluent stream pressure from a particular application is above that of the combined effluent in return conduit 20, no compression of the effluent is required. However, if the effluent pressure is below that in return conduit 20, it can be more cost effective for a particular application to send the effluent to the waste stream 50. The decision to direct a portion of effluent to waste stream 50 can also be a composition based decision. For example, the first heavily contaminated cycle of a cleaning application can be directed to waste stream 50, while subsequent cycles can be directed to the first purifying means 11.

The composition of the effluent directed by return conduit 20 to first purifying means 11 will be on average greater than about 50% carbon dioxide. Preferably, the average composition will more preferably be in excess of about 80% carbon dioxide, and more preferably in excess of about 90% carbon dioxide. The pressure of the combined effluent stream in return conduit 20 in this invention can be based on an optimization between the amount of carbon dioxide recovered and the purification costs. In general, the lower the pressure in return conduit 20, the greater the proportion of the effluent and carbon dioxide enriched phases that return conduit 20 can accept. The operating pressure for conduit 20 is preferably in the range of between about 90 to about 900 psia, more preferably in the range of between about 100 to about 400 psia and most preferably in the range of between about 150 to about 350 psia.

In another embodiment, a pressure-reducing bypass valve 51 connects supply conduit 12 and return conduit 20. This allows continuous operation of the first purifying means and its supply and return conduits, while the various applications and third purification means can be operated in batch mode.

In addition, the use of hold-up tanks (not shown) in the supply and return conduits can buffer the purification system from wide fluctuations in demand or supply. Hold-up in the return conduit can also smooth composition fluctuations.

Waste streams 44, 46, and 48 can be directed to appropriate disposal means or facilities that can recycle components for reuse.

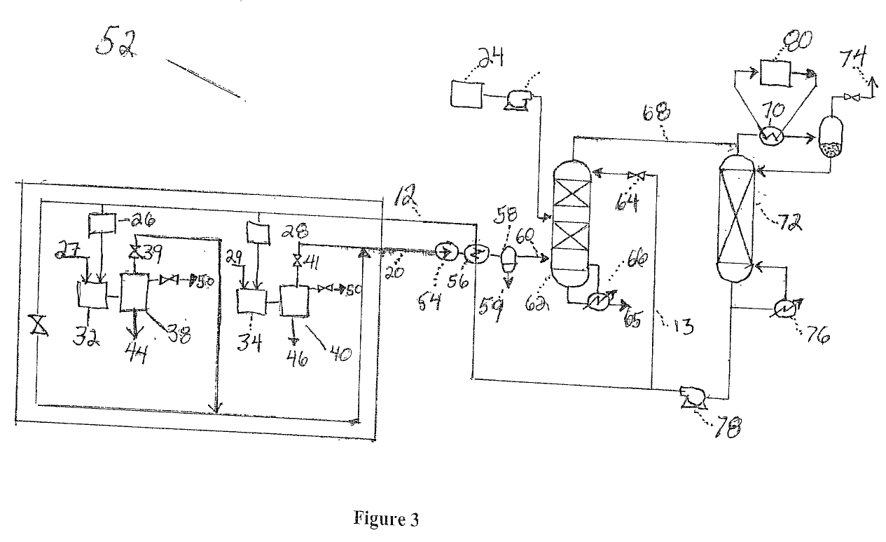

FIG. 3 shows apparatus 52 of the invention, which can also be used to conduct the method of the invention. Distinct applications 32 and 34 are supplied with a fluid feed from conduit 12. The fluid feed can be further customized by pressurization and heating, for example, in customization units 26 and 28 to meet the conditions required for each application. In FIG. 3, the second components are added directly to the applications via 27 and 29, rather than in 26 and 28.

Each application discharges a carbon dioxide/second component/contaminant effluent to third purification means 38 and 40. The portion of the carbon dioxide enriched phases produced by 38 and 40 that is above the pressure in return conduit 20 is directed to conduit 20. Gaseous exhaust to lower pressures can be vented to waste stream 50, or alternatively, can be compressed and also combined with the effluent in return conduit 20. Liquid and solid waste streams 44 and 46 can be sent to disposal or reclamation. Third purification means 38 and 40 can be heated to drive off carbon dioxide contained in a liquid phase to improve carbon dioxide recovery. Preferably, the performance of third purification means 38 and 40 is sufficient to avoid requiring return conduit 20 to be able to pass a multiphase mixture. Again, note that third purification means 38 and 40 are represented schematically and can in principle consist of one or more phase separators, distillation columns, adsorption beds and other purification devices tailored to the application.

Pressure control device 54 may be used to further reduce or increase pressure of the carbon dioxide in return conduit 20. The stream can be partially heated or cooled in exchanger 56. It then passes to phase separation device 58 to remove any particulates or droplets that may be present as a result of heating or cooling in exchanger 56 or due to inefficiencies in third purifying means 38 and 40. The stream is then directed via 60 into heavy contaminant removal distillation column 62. Liquid collected in separator 58 can be sent to waste stream 59. A portion of the high purity carbon dioxide can be taken via side stream 13 and directed through control valve 64 into the top of column 62. In addition, carbon dioxide from source 24 can also be introduced at an upper location of column 62. These streams serve to both cool the feed stream and to absorb heavy contaminants. The carbon dioxide from 24 can be required to overcome losses of carbon dioxide in the recycle system both at the application and with the impure streams leaving the purification system. Waste containing heavy impurities leaves the bottom of column 62 and can be directed to a liquid waste stream 59. Examples of heavy contaminants that can be removed here are organic solvents, such as acetone, hexane and water, among many others. A reboiler 65 provides stripping vapor in the column, if necessary, depending on the temperature of the gas stream entering column 62 from 58.

Stream 68 from column 62 can then be substantially condensed in exchanger 70 along with vapor overhead from light contaminant removal distillation column 72. The carbon dioxide liquid stream from the condenser flows into column 72. Light contaminants include methane, nitrogen, fluorine, and oxygen, among many others. The light contaminants are concentrated in the vapor overhead leaving the system as stream 74. Column 72 can be a vessel filled with suitable packing or trays to facilitate liquid and vapor contact. Exchanger 76 provides stripping vapor. Product liquid carbon dioxide can be taken from column 72 and compressed to an elevated pressure in pump 78 for conduits 13 and 12. The temperature of the fluid in conduit 12 can be adjusted by passage through exchanger 56.

Refrigeration system 80 can be used to perform the condensing duty for column 72. Optionally, the refrigeration system can be further heat integrated into the purification system by cooling the high-pressure refrigerant while providing the energy required in the reboilers 65 and 76. For example, reboil exchanger 65 may provide sub-cooling duty to a liquid refrigerant stream in system 80. Additionally, exchanger 56 may serve to reboil column 72 as well as cool the feed gas.

The operating pressure of the purification train is preferably in the range of between about 150 to about 1000 psia, more preferably in the range of between about 250 to about 800 psia, and most preferably in the range of between about 250 to about 350 psia. The pressure downstream of the pump in conduits 13 and 12 is preferably in the range of between about 775 to about 5000 psia, more preferably in the range of between about 800 to about 4000 psia, and most preferably in the range of between about 800 to about 3000 psia. The final purity of the carbon dioxide can be dictated by each application's requirements. Typical purity requirements are expected to be similar to those for ingredient-grade, bulk liquid carbon dioxide but with more stringent requirements for low vapor pressure contaminants. These can potentially leave a residue on the wafer surface. For example, non-volatile residue specifications are typically about 10 ppm for bulk liquid used in semiconductor manufacturing. The purity requirements for semiconductor applications can be below about 1 ppm. The preferred purification route can utilize distillation and phase separation to accomplish purification. However, if contaminants have vapor pressures that are close to carbon dioxide, then additional purification means can be provided. Examples of contaminants that fall into this category include some hydrocarbons (e.g. ethane), oxygenated hydrocarbons, halogens and halogenated hydrocarbons. The additional purification means may include catalytic oxidation, water scrubbing, caustic scrubbing and dryers.

The techniques used in semiconductor manufacturing are also being applied to other arenas where precision features are desired, such as the emerging field of micro electromechanical systems and micro fluidic systems, where a supercritical carbon dioxide process would also be useful.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for supplying carbon dioxide to a plurality of applications, comprising the steps of
a. directing a fluid feed, that includes a carbon dioxide component, from a first carbon dioxide purifying means to a plurality of applications including at least two distinct applications, whereby one or more contaminants are combined with the fluid at said applications, thereby forming an effluent at each said application, wherein each said effluent includes at least a portion of the carbon dioxide component and at least a portion of said contaminants;
b. directing at least a portion of at least one said effluent to said first purifying means; and
c. purifying the carbon dioxide component of said effluent at the first purifying means, thereby forming said fluid feed.

2. The method of claim 1 wherein said first purifying means produces at least one waste stream.

3. The method of claim 2, further including the step of adding a second component to at least one member of the group consisting of the fluid feed and at least one said application, wherein said second component is selected from the group consisting of co-solvents, surfactants, and chelators.

4. The method of claim 3, further including the step of changing at least one physical property of the fluid feed, said property selected from the group consisting of temperature and pressure.

5. The method of claim 4, whereby at least a portion of the carbon dioxide component of the fluid feed is formed into a supercritical fluid.

6. The method of claim 4, further including the step of adding carbon dioxide from a carbon dioxide source by a step selected from the group consisting of
a. combining the carbon dioxide from the source with at least one said effluent, whereby carbon dioxide from the source is purified by said first purifying means;
b. adding carbon dioxide from the source to said first purifying means while purifying said carbon dioxide component of said effluent in said first purifying means, whereby carbon dioxide from the source is purified by said first purifying means; and
c. pre-purifying carbon dioxide including the steps of
i) purifying carbon dioxide from the source in a second carbon dioxide purifying means, thereby creating a pre-purified feed, wherein said second purifying means includes at least one member of the group consisting of distillation, adsorption, phase separation, and catalytic oxidation; and
ii) adding said pre-purified feed to at least one member of the group consisting of the fluid feed, at least one said application, at least one said effluent, and said first purifying means.

7. The method of claim 6, wherein the carbon dioxide component of the effluent is purified at said first purifying means by
a. removing at least a portion of components that have vapor pressures different from the vapor pressure of carbon dioxide by using at least one member of the group consisting of means of catalytic oxidizing, distilling, phase separation, and adsorbing; and
b. directing the portion of components so removed to at least one waste stream.

8. The method of claim 7 wherein one or more third carbon dioxide purifying means partially purifies at least a portion of the carbon dioxide component of said effluent by
a. reducing the pressure of the effluent by an amount sufficient to separate the effluent into a plurality of phases, including at least one carbon dioxide enriched phase and at least one phase enriched in components other than carbon dioxide;
b. directing at least one carbon dioxide enriched phase to said first purifying means; and
c. directing at least one phase enriched in components other than carbon dioxide to at least one waste stream.

9. The method of claim 8 wherein said applications are selected from the group consisting of chemical fluid deposition, photoresist deposition, photoresist removal, and photoresist development.

10. The method of claim 9 further comprising the step of directing a portion of said fluid feed back to said first purifying means, thereby bypassing said applications and said third purifying means, whereby the first purifying means is operated as a continuous process.

11. A method for supplying carbon dioxide to a plurality of applications in a semiconductor manufacturing process, comprising the steps of
a. directing a fluid feed, that includes a carbon dioxide component, from a first carbon dioxide purifying means to a plurality of applications including at least two distinct applications, whereby one or more contaminants are combined with the fluid feed at said applications, thereby forming an effluent at each said application, wherein each said effluent includes at least a portion of the carbon dioxide component and at least a portion of said contaminants;
b. adding a second component to at least one member of the group consisting of the fluid feed and at least one said application, wherein said second component is selected from the group consisting of co-solvents, surfactants, and chelators;
c. changing at least one physical property of the fluid feed prior to at least one said application, said property selected from the group consisting of temperature and pressure;
d. partially purifying at least a portion of the carbon dioxide component of at least one said effluent by one or more third carbon dioxide purifying means including the steps of
i) reducing the pressure of the effluent by an amount sufficient to separate the effluent into a plurality of phases, including at least one carbon dioxide enriched phase and at least one phase enriched in components other than carbon dioxide;
ii) directing at least one carbon dioxide enriched phase to said first purifying means; and
iii) directing at least one phase enriched in components other than carbon dioxide to at least one waste stream; and
e. purifying one or more members of the group consisting of the carbon dioxide component of said effluent and said carbon dioxide enriched phase, at said first purifying means, thereby producing said fluid feed, by
i) removing at least a portion of components that have vapor pressures different from the vapor pressure of carbon dioxide by employing at least one step from the group consisting of catalytic oxidizing, distilling, phase separation, and adsorbing; and
ii) directing the portion of components so removed to at least one waste stream; and
f. adding carbon dioxide from a carbon dioxide source by a method selected from the group consisting of
i) combining carbon dioxide from the source with at least one said effluent, whereby carbon dioxide from the source is purified by said first purifying means;
ii) adding carbon dioxide from the source to said first purifying means while purifying said carbon dioxide component of said effluent in said first purifying means, whereby carbon dioxide from the source is purified by said first purifying means; and
iii) pre-purifying carbon dioxide including the steps of
(1) purifying carbon dioxide from the source in a second carbon dioxide purifying means, thereby creating a pre-purified feed, wherein said second means includes at least one step selected from the group consisting of distillation, adsorption, phase separation, and catalytic oxidation; and
(2) adding said pre-purified feed to at least one member of the group consisting of the fluid feed, at least one said application, at least one said effluent, and said first purifying means; and
g. directing a portion of said fluid feed back to said first purifying means, thereby bypassing said applications and said third purifying means, whereby the first purifying means is operated as a continuous process.

12. A system for supplying carbon dioxide to a plurality of semiconductor manufacturing applications, comprising
a. a first carbon dioxide purifying means, which purifies a carbon dioxide component of an effluent to form a fluid feed that includes the carbon dioxide as a component of said fluid feed, wherein said first purifying means includes at least one member of the group consisting of a catalytic oxidizer, a distillation column, a phase separator, and an adsorption bed;
b. a supply conduit for directing said fluid feed from the first purifying means to a plurality of applications comprising at least two distinct applications, whereby one or more contaminants are combined with the fluid, thereby forming an effluent at each said application, wherein each said effluent includes at least a portion of the carbon dioxide component and at least a portion of said contaminants; and
c. a return conduit for directing said effluent from at least one said application to said first purifying means.

13. The system of claim 12, wherein said first purifying means further includes means to direct a portion components of the effluent other than carbon dioxide to at least one waste stream.

14. The system of claim 13, further including means to add a second component into at least one member of the group consisting of the supply conduit and at least one said application.

15. The system of claim 14, further including means selected from the group consisting of a heat exchanger and a pressure controller, wherein said means is at a location selected from the group consisting of the supply conduit and at least one said application.

16. The system of claim 15, further including
a. a carbon dioxide source; and
b. means to purify and add carbon dioxide from said source, said means selected from the group consisting of
i) means to direct carbon dioxide from the source to at least one member of the group consisting of the first purifying means, an effluent, and the return conduit, whereby carbon dioxide from the source is purified by said first purifying means before being directed to said applications; and
ii) means to purify and add carbon dioxide from the source including
(1) means to direct carbon dioxide from said source to a second carbon dioxide purifying means;
(2) a second carbon dioxide purifying means, thereby producing a purified feed, wherein said second purifying means includes at least one member of the group consisting of a distillation column, an adsorption bed, a phase separator, and a catalytic oxidizer; and
(3) means to add a purified feed to at least one member of the group consisting of the supply conduit, at least one said application, the return conduit, and said first purifying means.

17. The system of claim 16, wherein said first purifying means removes at least a portion of components that have vapor pressures different from the vapor pressure of carbon dioxide.

18. The system of claim 17 wherein said first purifying means includes a plurality of distillation columns, wherein at least one said column removes at least a portion of components that have vapor pressures higher than carbon dioxide and at least one said column removes at least a portion of components that have vapor pressures lower than carbon dioxide.

19. The system of claim 18 further including one or more third carbon dioxide purifying means that partially purifies at least a portion of the carbon dioxide component of at least one said effluent by
a. reducing the pressure of the effluent by an amount sufficient to separate the effluent into a plurality of phases, including at least one carbon dioxide enriched phase and at least one phase enriched in components other than carbon dioxide;
b. directing at least one carbon dioxide enriched phase to said first purifying means; and
c. directing at least one phase enriched in components other than carbon dioxide to at least one waste stream.

20. The system of claim 19 further means to direct a portion of said fluid feed back to said first purifying means, thereby bypassing said applications and said third purifying means, whereby the first purifying means is operated as a continuous process.

21. A system for supplying carbon dioxide to a plurality of semiconductor manufacturing applications, comprising
a. a supply conduit for directing a fluid feed from a first purifying means to a plurality of applications comprising at least two distinct applications, whereby one or more contaminants are combined with the fluid, thereby forming an effluent at each said application, wherein each said effluent includes at least a portion of the carbon dioxide component and at least a portion of said contaminants;
b. means selected from the group consisting of a heat exchanger and a pressure controller, wherein said means is at a location selected from the group consisting of the supply conduit and at least one said application;
c. means to add a second component, wherein said means is at a location selected from the group consisting of the supply conduit and said applications;
d. a return conduit for directing said effluent from at least one said application to at least one member of the group consisting of said first purifying means and a third purifying means;
e. one or more third purifying means that partially purifies at least a portion of the carbon dioxide component of at least one said effluent by
i) reducing the pressure of the effluent by an amount sufficient to separate the effluent into a plurality of phases, including at least one carbon dioxide enriched phase and at least one phase enriched in components other than carbon dioxide;
ii) directing at least one carbon dioxide enriched phase to said first purifying means; and
iii) directing at least one phase enriched in components other than carbon dioxide to at least one waste stream; and
f. a first carbon dioxide purifying means, which purifies at least one member of the group consisting of a carbon dioxide component of an effluent and a carbon dioxide enriched phase, thereby forming a fluid feed that includes carbon dioxide as a component of said fluid feed, including
i) at least one distillation column that removes at least a portion of components that have vapor pressures higher than that of carbon dioxide; and
ii) at least one distillation column that removes at least a portion of components that have vapor pressures lower than that of carbon dioxide;
iii). means to direct at least a portion of components that have vapor pressures different from that of carbon dioxide to at least one waste stream;
g. means to direct a portion of said fluid feed back to said first purifying means, thereby bypassing said applications and said third purifying means, whereby the first purifying means is operated as a continuous process;
h. a carbon dioxide source; and
i. means to purify and add additional carbon dioxide from said source, said means selected from the group consisting of
i) means to direct carbon dioxide from a carbon dioxide source to at least one member of the group consisting of the first purifying means, the third purifying means, and the return conduit, whereby carbon dioxide from the source is purified by said first purifying means before being directed to said applications; and
ii) means to add purified carbon dioxide from a carbon dioxide source including
(1) means to direct carbon dioxide from said source to a second carbon dioxide purifying means;
(2) a second carbon dioxide purifying means, thereby producing a purified feed, wherein said second purifying means includes at least one member of the group consisting of a distillation column, an adsorption bed, a phase separator, and a catalytic oxidizer; and
(3) means to add a purified feed to at least one member of the group consisting of the supply conduit, at least one said application, the return conduit, and said first purifying means.
